(19) United States
(12) Patent Application Publication
(10) Pub. No.: US 2026/0359826 A1
(43) Pub. Date: Nov. 12, 2026

(54) METHODS AND SYSTEMS FOR DETECTING AND ASSESSING CYBERSECURITY RISKS OF MERCHANT WEBSITES

(71) Applicant: Mastercard International Incorporated, Purchase, NY (US)

(72) Inventors: Svetlana Ulianova, Toronto (CA); Wenying Sung, Union City, NJ (US)

(73) Assignee: Mastercard International Incorporated, Purchase, NY (US)

(21) Appl. No.: 19/668,540

(22) Filed: May 5, 2026

Related U.S. Application Data
(60) Provisional application No. 63/802,273, filed on May 8, 2025.

(51) Int. Cl. G06Q 20/40

(52) U.S. Cl. CPC G06Q 20/4016

(57) ABSTRACT

The disclosure describes systems and techniques for training and validating a machine learning model to detect compromised merchant websites. The techniques involve retrieving a training dataset containing observational data from merchant website scans and transactional data from payment processors. The data is preprocessed by imputing missing values and encoding categorical features into a machine-readable format. Feature engineering is applied to transform raw data into structured feature vectors based on key attributes. A digital skimmer breach risk score model is generated by training a machine learning model using the processed dataset, optimizing a loss function to minimize misclassifications. The model is validated using a testing dataset, which includes additional observational and transactional data, to evaluate performance metrics such as precision and recall.

### CROSS-REFERENCE TO RELATED APPLICATIONS

The present application claims priority from U.S. Provisional Patent Application No. 63/802,273, filed May 8, 2025, and titled METHODS AND SYSTEMS FOR DETECTING AND ASSESSING CYBERSECURITY RISKS OF MERCHANT WEBSITES. The entire disclosure of the aforementioned priority application is hereby incorporated by reference herein.

### BACKGROUND OF THE DISCLOSURE

The field of the disclosure relates generally to identifying vulnerabilities in merchant websites, and, more particularly, to detecting the presence of malicious code such as digital skimmers and assessing a risk of compromise of merchant websites.

Digital skimming attacks on merchant websites have emerged as a significant cybersecurity challenge, leading to financial fraud, data breaches, and reputational damage for merchants and payment processors. A digital skimmer is malicious code injected into websites to steal sensitive information, such as payment card details, directly from unsuspecting customers during transactions.

Traditional methods of detecting malicious code often rely on static website scanning. Such static scanning, however, is limited to identifying known attack patterns or signature-based threats. These methods fail to account for the dynamic and evolving nature of digital skimming techniques. Additionally, these approaches lack integration with broader contextual data, such as a merchant's transaction history, industry classification, or geographic region, which are important for understanding a merchant's risk profile.

### BRIEF DESCRIPTION OF THE DISCLOSURE

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a system is provided. The system includes a data store containing training and testing datasets. The training and testing datasets include observational data derived from merchant website scans and transactional data from one or more payment processors. The system further includes one or more processors and a memory device. The memory device has executable instructions that, when executed by the processors, perform various operations. The operations include retrieving the training dataset from the data store and preprocessing the training dataset by imputing missing values and encoding categorical features into a machine-readable format. The operations include performing feature engineering to transform the raw data of the training dataset into structured feature vectors based on one or more attributes. The processor generates a digital skimmer breach risk score model by training a machine learning model using the preprocessed and engineered dataset and optimizing a loss function to minimize misclassifications between compromised and non-compromised websites. Additionally, the testing dataset is retrieved by the processor, and the digital skimmer breach risk score model is validated using the testing dataset to evaluate performance metrics such as precision and recall.

In another aspect, a method is provided. The method includes retrieving a training dataset from a data store. The training dataset includes observational data derived from merchant website scans and transactional data from one or more payment processors. The method includes preprocessing the training dataset by imputing missing values and encoding categorical features into a machine-readable format. The method also includes performing feature engineering to transform raw data into structured feature vectors based on one or more attributes. A digital skimmer breach risk score model is generated by training a machine learning model on the preprocessed and engineered dataset. The method includes optimizing a loss function to minimize misclassifications between compromised and non-compromised websites. The method further includes retrieving a testing dataset from the data store. The testing dataset includes additional observational and transactional data. The method also includes validating the digital skimmer breach risk score model on the testing dataset to evaluate performance metrics, including precision and recall.

In yet another aspect, a non-transitory computer-readable medium is provided. The non-transitory computer-readable medium includes executable instructions that, when executed by a computer with one or more processors, cause the processors to perform specific operations. The operations include retrieving a training dataset from a data store. The training dataset includes observational data derived from merchant website scans and transactional data from one or more payment processors. The instructions also cause the processor to preprocess the training dataset by imputing missing values and encoding categorical features into a machine-readable format. The operations further involve performing feature engineering to transform raw data into structured feature vectors based on one or more attributes, and generating a digital skimmer breach risk score model by training a machine learning model using the preprocessed dataset. The training optimizes a loss function to minimize misclassifications between compromised and non-compromised websites. Additionally, the operations include retrieving a testing dataset from the data store. The testing dataset includes observational and transactional data. The operations include validating the digital skimmer breach risk score model on the testing dataset to evaluate performance metrics, including precision and recall.

A variety of additional aspects will be set forth in the detailed description that follows. These aspects can relate to individual features and to combinations of features. Advantages of these and other aspects will become more apparent to those skilled in the art from the following description of the exemplary embodiments which have been shown and described by way of illustration. As will be realized, the present aspects described herein may be capable of other and different aspects, and their details are capable of modification in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with an embodiment thereof. Further, wherever possible, the following description refers to the reference numerals included in the following figures, in which features depicted in multiple figures are designated with consistent reference numerals.

FIG. 1 is a schematic diagram depicting an exemplary system to assess and/or identify merchant Internet-based resources with one or more vulnerabilities or digital security threats, in accordance with an embodiment of the present disclosure;

FIG. 2 is an example configuration of a vulnerability assessment monitor for use in the system shown in FIG. 1;

FIG. 3 is an example configuration of a computing device for use in the system shown in FIG. 1;

FIG. 4 is an exemplary data flow process for training and applying a machine learning model for use in the system shown in FIG. 1;

FIG. 5 is a flowchart illustrating an exemplary computer-implemented method for training a digital skimmer breach risk score model use in the system shown in FIG. 1; and

FIG. 6 is a flowchart illustrating an exemplary computer-implemented method for utilizing the digital skimmer breach risk score model of FIG. 5 to predict whether a merchant website includes a digital skimmer and/or malicious code, in accordance with an embodiment of the present disclosure.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION OF THE DISCLOSURE

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized, and changes may be made without departing from the scope of the claims. The following description is, therefore, not limiting. The scope of the present invention is defined only by the appended claims, along with the full scope of equivalents to which such claims are entitled.

Broadly, the disclosure presents machine learning (ML) techniques for identifying websites, and particularly merchant websites, that are likely to contain undetected malicious code, such as digital skimmers, or to be at high risk for a digital skimming attack. The disclosed techniques combine website observational data derived from scanning merchant websites, and transactional data associated with the merchant or merchant website, obtained from a payment processor, such as the Mastercard® payment network. (Mastercard is a registered trademark of Mastercard International Incorporated). By integrating these data sources, the disclosed techniques construct a comprehensive view of a merchant's security posture and risk profile.

The disclosed techniques include a digital skimmer breach risk score model that operates as an ML classifier, trained on a large dataset encompassing hundreds of thousands of merchant websites. The training data includes examples of both skimmer-compromised and secure websites. The digital skimmer breach risk score model leverages a variety of features, including website configuration data, software version and patching information, encryption practices, network filtering, and characteristics of the merchant's transaction history, such as transaction volume, frequency of fraudulent transactions, business type, and geographic location.

The digital skimmer breach risk score model is adaptable, allowing for the adjustment of precision and recall thresholds based on testing and performance needs. The digital skimmer breach risk score model may be deployed or used in a triggered manner. In instances where the digital skimmer breach risk score model identifies a potential digital skimmer or a high-risk merchant website, notifications and alerts are generated and transmitted to relevant parties. This may include alerts to the merchant, payment processors, and/or issuers of transaction cards potentially impacted by the compromised website. Additionally, the system may flag the merchant website for further investigation and add it to a monitored list of potentially compromised websites.

The digital skimmer breach risk score model represents a technological improvement to existing cybersecurity systems. It enables the real-time and automated detection of digital skimmers using a novel integration of website configuration data and transactional history, processed through a machine learning classification engine. The system transforms disparate raw data into structured, interpretable feature vectors, mapped within a latent feature space to yield precise risk predictions. The system enhances the ability to detect, classify, and respond to cybersecurity threats dynamically, improving the computer's functionality and contributing meaningfully to the technical field of network security.

### Exemplary System

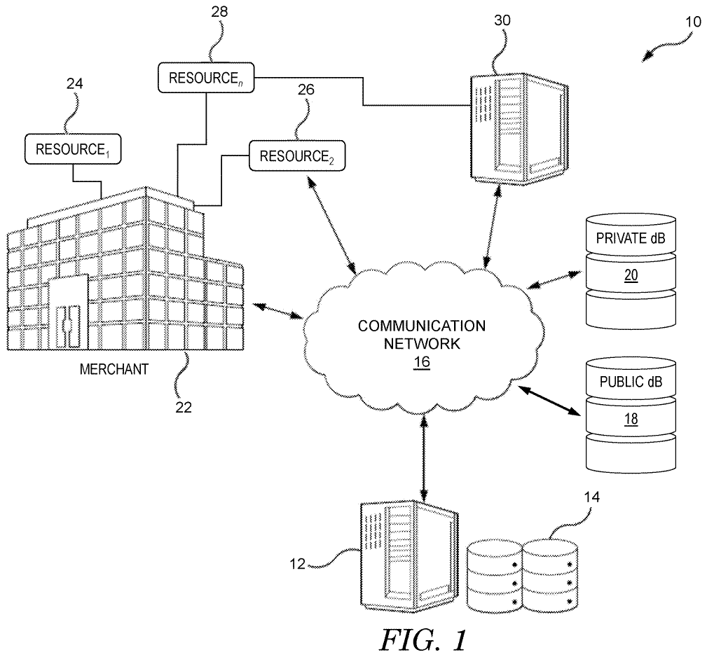

FIG. 1 depicts an exemplary system 10 in which embodiments of a vulnerability assessment monitor 12 may be utilized to assess and/or identify merchant Internet-based resources with one or more vulnerabilities or digital security threats, notably the presence of malicious software designed to steal customer payment information through unauthorized digital skimmers. The system 10 includes a communication network 16 coupled in communication to the vulnerability assessment monitor 12, a public database 18, a private database 20, a merchant 22, and a third-party computing device 30. The vulnerability assessment monitor 12 includes a vulnerability assessment data store 14 coupled in communication thereto.

Each of the public database 18, the private database 20, the merchant 22, and the third-party computing device 30 may include a desktop computer, a laptop or tablet computer, an application server, a database server, a file server, or the like, or combinations thereof, configured to periodically or continuously provide data and/or data updates to the vulnerability assessment monitor 12 to store, for example, in the vulnerability assessment data store 14. The vulnerability assessment monitor 12 may include and/or work in conjunction with application servers, database servers, file servers, gaming servers, mail servers, print servers, or the like, or combinations thereof. Furthermore, the vulnerability assessment monitor 12 may include a plurality of servers, virtual servers, or combinations thereof.

The communication network 16 may provide wired and/or wireless communication between the public database 18, the private database 20, the merchant 22, the third-party computing device 30, and the vulnerability assessment monitor 12. Each of the public database 18, the private database 20, the merchant 22, the third-party computing device 30, and the vulnerability assessment monitor 12 may be configured to send data to and/or receive data from the communication network 16 using one or more suitable communication protocols, which may be the same communication protocols or different communication protocols as one another. Suitable protocols include, but are not limited to, Hypertext Transfer Protocol (HTTP), File Transfer Protocol (FTP), Domain Name System (DNS), Internet Protocol (IP), Simple Network Management Protocol (SNMP), Transmission Control Protocol (TCP), and User Datagram Protocol (UDP). The term “Internet Protocol” includes Internet Protocol version 4 (IPv4), Internet Protocol version 6 (IPv6), a future-developed internet protocol, or combinations thereof.

The communication network 16 may include one or more telecommunication networks, nodes, and/or links used to facilitate data exchanges between one or more devices and may facilitate a connection to the Internet for devices configured to communicate with the communication network 16. The communication network 16 may include local area networks, metro area networks, wide area networks, cloud networks, the Internet, cellular networks, plain old telephone service (POTS) networks, and the like, or combinations thereof.

The communication network 16 may be wired, wireless, or combinations thereof and may include components such as modems, gateways, switches, routers, hubs, access points, repeaters, towers, and the like. The public database 18, the private database 20, the merchant 22, the third-party computing device 30, and the vulnerability assessment monitor 12 may connect to the communication network 16 either through wires, such as electrical cables or fiber optic cables, or wirelessly. Wireless connection types may include, for example: radio frequency (RF) communication using wireless standards such as cellular 3G, 4G, 5G, and the like; Institute of Electrical and Electronics Engineers (IEEE) 802.11 standards such as Wi-Fi; IEEE 802.16 standards such as WiMAX; IEEE 802.15.1 such as Bluetooth™; or combinations thereof. In aspects in which the communication network 16 facilitates a connection to the Internet, data communications may take place over the communication network 16 via one or more suitable Internet communication protocols. For example, the communication network 16 may be implemented as a wireless telephony network (e.g., GSM, CDMA, LTE, etc.), a Wi-Fi network (e.g., via one or more IEEE 802.11 Standards), a WiMAX network, a Bluetooth™ network, etc.

In the example embodiment, the communication network 16 provides connectivity to the merchant 22 (e.g., via a computing device or server). The merchant 22 may be a business, a service provider, or any other organization that provides or uses network-connected devices or services. In the example, the merchant 22 is typically associated with goods and/or services offered for sale and sold to a consumer (not shown). The merchant 22 includes, for example, a physical location and/or a virtual location such as an Internet-based storefront.

The merchant's network-connected devices or services utilize network resources, such as resources 1 through n, represented by reference numerals 24, 26, and 28, respectively. The resources 24, 26, and 28 belong to or are associated with the merchant 22. The network resources 24, 26, and 28 may include, for example, a hostname, an IP address, a domain name, a netblock, a uniform resource location (URL), and the like. In the exemplary embodiment, the resources, such as the resource 24, may be connected to the communication network 16 through a connection shared by merchant 22. Other resources, such as the resource 26, may be connected directly to the communication network 16. Additionally, other resources, such as the resource 28, may be hosted by a third-party, such as the third-party computing device 30, shared by the merchant 22 and others. The resources 24, 26, and 28 may be used internally by the organization, may be accessed by members of the public via communication network 16, or may be used to provide hosted data or services to a client (not shown), which may be another organization or an individual.

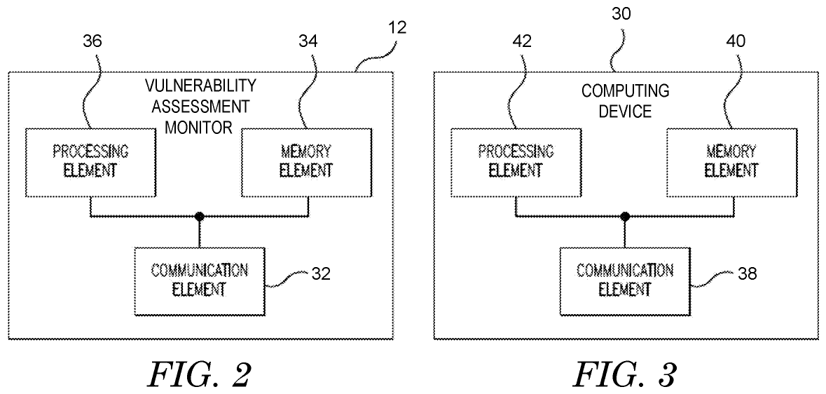

The vulnerability assessment monitor 12 may generally request and retain electronic data and may respond to requests to retrieve data, as well as to store data. The vulnerability assessment monitor 12 may be configured to include or execute software, such as file storage applications, database applications, email or messaging applications, web server applications, and/or artificial intelligence (AI) or machine learning (ML) software/models or the like. As indicated in FIG. 2, the vulnerability assessment monitor 12 may broadly include a communication element 32, a memory element 34, and a processing element 36. Likewise, as indicated in FIG. 3, the third-party computing device 30 may broadly include a communication element 38, a memory element 40, and a processing element 42.

The communication elements 32, 38 may each generally allow communication with external systems or devices, including the communication network 16, via wireless communication and/or data transmission over one or more direct or indirect radio links between devices. The communication elements 32, 38 each may include signal or data transmitting and receiving circuits, such as antennas, amplifiers, filters, mixers, oscillators, digital signal processors (DSPs), and the like. The communication elements 32, 38 each may establish communication wirelessly by utilizing RF signals and/or data that comply with communication standards such as cellular 3G, 4G, or 5G, Wi-Fi, WiMAX, Bluetooth™, and the like, or combinations thereof. In addition, the communication elements 32, 38 each may utilize communication standards such as ANT, ANT+, Bluetooth™ low energy (BLE), the industrial, scientific, and medical (ISM) band at 2.4 gigahertz (GHz), or the like.

Alternatively, or in addition, the communication elements 32, 38 each may establish communication through physical connectors or couplers that receive metal conductor wires or cables that are compatible with networking technologies, such as ethernet. In certain embodiments, the communication elements 32, 38 each may also couple with optical fiber cables. The communication elements 32, 38 each may be in communication with corresponding ones of the processing elements 36, 42 and the memory elements 34, 40, via, e.g., wired or wireless communication.

The memory elements 34, 40 each may include electronic hardware data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory elements 34, 40 each may be embedded in, or packaged in the same package as, the corresponding one of the processing elements 36, 42. The memory elements 34, 40 each may include, or may constitute, a “computer-readable medium.” The memory elements 34, 40 each may store computer-executable instructions, code, code segments, software, firmware, programs, applications, apps, modules, agents, services, daemons, or the like that are executed by the processing elements 36, 42, including—in the case of processing element 36 and the memory element 34—the AI or ML software/models or the like. The memory elements 34, 40 each may also store settings, data, documents, sound files, photographs, movies, images, databases, and the like, including the items described throughout this disclosure.

The processing elements 36, 42 each may include electronic hardware components such as processors. The processing elements 36, 42 each may include digital processing unit(s). The processing elements 36, 42 each may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processing elements 36, 42 each may generally execute, process, or run computer-executable instructions, code, code segments, software, firmware, programs, applications, apps, modules, agents, processes, services, daemons, or the like, including—in the case of processing element 36—one or more AI or ML software/models and/or data analysis processes described throughout this disclosure. The processing elements 36, 42 each may also include hardware components such as finite-state machines, sequential and combinational logic, and other electronic circuits that can perform the functions necessary for the operation of the current disclosure. The processing elements 36, 42 each may be in communication with the other electronic components through serial or parallel links that include address busses, data busses, control lines, and the like. Through hardware, software, firmware, or combinations thereof, the processing elements 36, 42 each may be configured or programmed to perform the functions described herein below.

In the example, the vulnerability assessment data store 14 electronically stores information regarding the resources 24, 26, and 28 in a relational database, such as a PostgreSQL® database. The vulnerability assessment data store 14 includes one or more records for storing information regarding the merchant 22 and resources 24, 26, and 28. The vulnerability assessment monitor 12 reads and writes such information to and from the vulnerability assessment data store 14, which database may be integrated with, or internal to, the vulnerability assessment monitor 12; external to the vulnerability assessment monitor 12 and accessible over communication network 16; housed on a suitable database server (not shown); or any combination thereof.

In the exemplary embodiment, the public database 18 is a database that is publicly available over the communication network 16. The public database 18 may contain information regarding the resources 24, 26, and 28. Examples of a public database, such as the public database 18, include a domain name server, a WHOIS server, an IP address numbering authority server, a route server, a public domain software repository, and the like. The private database 20 is a database that is available over the communication network 16 only to one or more registered users. The private database 20 may contain similar data as the public database 18, and it may also contain proprietary data regarding the resources 24, 26, and 28. The proprietary data can include, for example, aggregated data, internal enterprise data, or other paid-for data useful in evaluating information security of the resources.

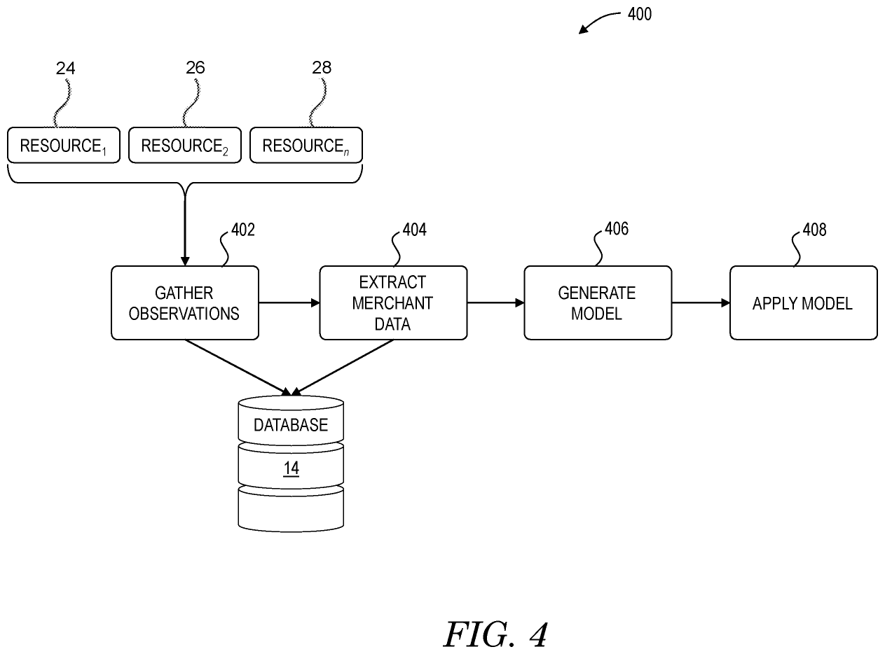

FIG. 4 is an exemplary high-level data flow process 400 to train a digital skimmer breach risk score model for detecting digital skimmers and to apply the trained digital skimmer breach risk score model to merchant websites, in accordance with embodiments of the present disclosure. In the example, the process 400 integrates data gathering, feature extraction, model training, and real-time or on-demand application of the digital skimmer breach risk score model to identify websites vulnerabilities. The data flow process 400 described below may be performed by the vulnerability assessment monitor 12. Also, the operations may be implemented as instructions, code, code segments, code statements, a program, an application, an app, a process, a service, a daemon, or the like, and may be stored on a computer-readable storage medium, such as the memory element 34 (shown in FIG. 2).

At 402, the data flow process 400 includes gathering observations from the merchant websites, and in particular, gathering website data to use as a training dataset from and/or associated with the merchant resources, such as resources 24, 26, and 28. The foundation of the digital skimmer breach risk score model relies on a comprehensive training dataset consisting of, for example, data gathered from tens of thousands to hundreds of thousands of merchant websites, ensuring broad coverage across various industries and regions. In an example, the website data may be stored in the vulnerability assessment data store 14.

At 404, the data flow process 400 includes extracting observational and transactional data, for example, into a unified feature set to facilitate developing the digital skimmer breach risk score model. For example, the dataset may be parsed to identify certain features and may be automatically labeled using one or more models to differentiate between websites with known digital skimmers, those free of malicious code, and those with unknown statuses. In addition, in some embodiments, portions of data of the training dataset may be manually labelled in instances where automatically labeling of the features may fail. The observational data may include, for example, data derived from website scans. For example, the observational data may include cybersecurity indicators, such as out-of-date software and patching data, misconfigured network data (such as exposed databases and weak encryption (e.g., lack of HTTPS)), domain name system (DNS) vulnerabilities, high host fragmentation, the presence of malicious hosts, and the like. The observational data many be sourced from the merchant website and/or from one or more of the private or public databases 18 and 20.

The transactional data may be sourced from one or more payment processors associated with a merchant(s) associated with the resources 24, 26, and 28. For example, scanning of the merchant websites may provide merchant and payment processor data. This data may be used to retrieve merchant records from the one or more payment processors, such as one or more of the private or public databases 18 and 20. The merchant records may include data associated with business and fraud-related insights, such as geographic region of operation, transaction volume, merchant size, industry classifications (e.g., accommodations, financial services), frequency and volume of fraudulent transactions, and the like. The dual-source feature set facilitate ensuring that technical and contextual factors contributing to digital skimmer risk are captured, identified, and used to generate the digital skimmer breach risk score model. In an example, the observational and/or transactional data may be stored in the vulnerability assessment data store 14.

In an embodiment, all data gathered and processed by the process 400, including transactional records and observational website data, adheres to strict privacy and security standards. Sensitive data may be anonymized during preprocessing to ensure compliance with regulations such as PCI DSS and GDPR. Additionally, all data transmissions between the data store 14 and/or databases 18 and 20 and the vulnerability assessment monitor 12 may be encrypted, for example, using secure protocols like TLS.

At 406, the data flow process 400 includes generating the digital skimmer breach risk score model for detecting differences between digital skimmer and non-digital skimmer (or malicious code) websites. For example, the digital skimmer breach risk score model may be trained to identify distinguishing characteristics of digital skimmer and non-digital skimmer websites associated with merchants, such as the merchant 22 (shown in FIG. 1), and provide one or more outputs representative of a result.

At 408, the data flow process 400 includes applying the generated digital skimmer breach risk score model to various merchant websites. For example, in an embodiment, after being trained, the digital skimmer breach risk score model may be applied to other merchant websites, either on-demand or through an automated application process, to detect vulnerabilities associated with digital skimmers and/or other malicious code. In an embodiment, merchant websites with detected vulnerabilities may be flagged as potentially compromised and merchant websites without detected vulnerabilities may remain unflagged or be flagged as low risk or clean. Additionally, one or more actionable mitigation steps may be suggested. For example, the mitigation steps may include updating outdated software, improving encryption practices, reducing host fragmentation, addressing flagged fraudulent transactions, and/or monitoring or requiring additional authentication steps for high-risk transactions originating from the website.

### Computer-Implemented Methods

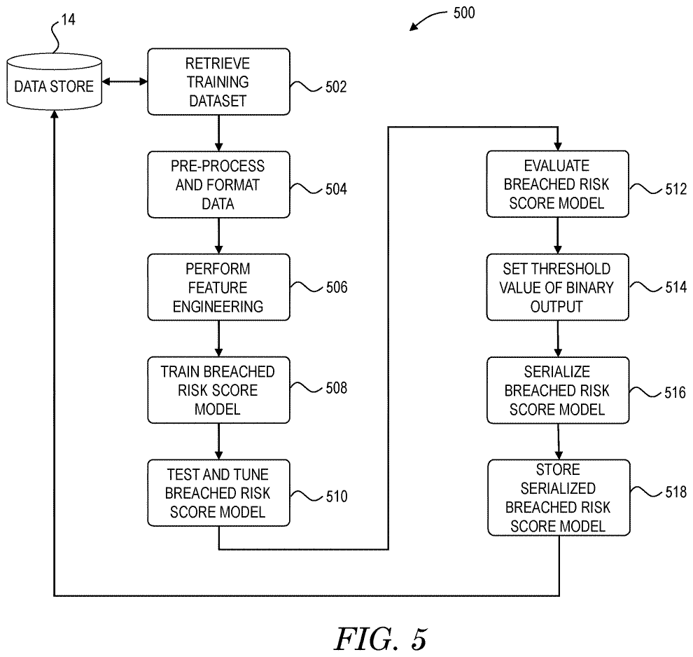

FIG. 5 is a flowchart illustrating an exemplary computer-implemented method 500 for training a digital skimmer breach risk score model, in accordance with one embodiment of the present disclosure. The operations described herein may be performed in the order shown in FIG. 5 or may be performed in a different order. Furthermore, some operations may be performed concurrently as opposed to sequentially. In addition, some operations may be optional.

The computer-implemented method 500 is described below, for ease of reference, as being executed by exemplary devices and components introduced with the embodiments illustrated in FIGS. 1-4. In one embodiment, the method 500 may be implemented by the vulnerability assessment monitor 12 (shown in FIG. 1). While operations within the method 500 are described below regarding the vulnerability assessment monitor 12, the method 500 may be implemented on other computing devices and/or systems through the utilization of processors, transceivers, hardware, software, firmware, or combinations thereof. However, a person having ordinary skill will appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

As discussed herein, the digital skimmer breach risk score model can generate both a likelihood (or probability) of a digital skimmer's presence and a corresponding binary classification, depending on a selected threshold (e.g., 0.5). When the output exceeds this threshold, the model classifies a merchant website as “at risk”; otherwise, it is deemed “not at risk.” This threshold-based approach streamlines cybersecurity decision-making by providing a clear binary outcome, while still preserving the granularity offered by the underlying likelihood score. Consequently, the model accommodates scenarios requiring either detailed probability assessments or quick, decisive actions.

As discussed herein, the digital skimmer breach risk score model is an ML classifier that can generate both a likelihood (or probability) of a digital skimmer's presence and, by applying a threshold (e.g., 0.5), a binary classification. In the digital skimmer breach risk score model, the goal is to classify each instance—in this case, each merchant website—as either “at risk” of having a digital skimmer or “not at risk.” The binary nature of the digital skimmer breach risk score model simplifies decision-making by focusing on two outcomes (risk or no risk) rather than a range or multi-class prediction, which would involve several distinct risk levels. The binary approach is particularly effective for cybersecurity applications, where quick, decisive action may be required. The output of the digital skimmer breach risk score model may be interpreted as a likelihood or probability of a digital skimmer's presence, allowing for straightforward alerts and risk management.

In the exemplary embodiment, at operation 502, the vulnerability assessment monitor 12 retrieves the training dataset from the vulnerability assessment data store 14. As described above, the training dataset includes observational and transactional data. In the exemplary embodiment, the training dataset includes data sourced from at least two data sources, including payment processors and cybersecurity scanners/monitors.

The observational data comprises data obtained by scanning merchant websites and includes website configurations, software versions, and encryption practices. In an embodiment, one or more observational data points collected may include form fields, input types (e.g., fields for credit card information), JavaScript elements visible to scanning technology, encryption practices, and software version information. Additional site security features may include the presence of outdated software, exposed databases, and potential DNS vulnerabilities. Network complexity, such as the number of hosting providers, may also be evaluated, as more fragmented hosting structures can introduce greater security risks.

The transactional data comprises data sourced from one or more payment processors, such as Mastercard, and provides a historical profile of each merchant's transaction patterns. The transactional data may include transaction volume and frequency, fraud occurrence rates, business type, and region. Geographic indicators and high-risk industries, such as financial services or e-commerce, may further facilitate refining the risk profile of the merchant. Collectively, these features may allow the digital skimmer breach risk score model to distinguish between merchant websites likely to contain digital skimmers and those at lower risk.

At operation 504, the observational and transactional data are pre-processed and formatted for compatibility with the digital skimmer breach risk score model. Categorical features (e.g., industry type, region) may be encoded as needed, while numerical features (e.g., transaction volume) may be normalized. As described above, the digital skimmer breach risk score model may be trained on a training dataset including tens to hundreds of thousands of merchant websites, labeled based on the known presence or absence of digital skimmers. The training dataset may include a wide range of merchant types, industries, and geographic locations, ensuring that the digital skimmer breach risk score model generalizes well across different merchant profiles. By utilizing a diverse training dataset, the digital skimmer breach risk score model may capture variations in digital skimmer behavior and website configurations, making the digital skimmer breach risk score model more resilient to unseen data.

In one embodiment, outlier detection and handling may be incorporated into the data pre-processing to ensure the quality and reliability of the training dataset. Numerical attributes, such as transaction volume and cybersecurity scores, may be examined for extreme values, for example, using z-scores or interquartile range (IQR) thresholds. Values exceeding these thresholds may be capped to the 95th percentile to prevent skewing the model. For categorical attributes, anomalous entries may be replaced with a placeholder category, ensuring that the dataset remains consistent and robust during training.

In an example embodiment, approximately one and one half percent (1.5%) of the training dataset includes breached merchant websites known to include digital skimmers and/or malicious code. The various types of breaches may include, for example, digital skimming, common point of purchase (CPP)/dark web model-identified breach, and observed security breaches by a cybersecurity scanner/monitor.

Digital skimming may include the unauthorized injection of malicious code into a website to steal sensitive payment information entered by customers, such as credit and/or debit card details. For example, malicious scripts may be embedded in payment forms or checkout pages of a merchant's website. The scripts may capture and exfiltrate data when customers enter their payment information. Indicators of digital skimmers may include, for example unexpected or modified scripts on a website and/or unusual HTTP requests to external, unknown servers.

A CPP breach may occur when a fraud investigator identifies a single merchant as the origin of compromised card details, such as through aggregation or analysis of fraud reports from payment cards previously used at the same merchant. Additionally, dark web marketplaces may list payment card details with metadata indicating the compromised merchant. A CPP breach may be more easily identified based on a high concentration of fraud linked to payment cards used at one merchant and/or the merchant's name appearing on dark web listings of stolen payment card data.

Observed security breaches by a cybersecurity scanner/monitor may include security vulnerabilities or compromises directly observed through risk reduction activities, such as penetration testing, vulnerability scans, or real-time monitoring of merchant websites. For example, risk monitoring systems may detect vulnerabilities such as open ports, SSL/TLS configuration, or misconfigured access controls.

Approximately ninety nine percent (99%) of the dataset is known to be free of digital skimmers and/or malicious code (i.e., unbreached). The merchant websites with known properties may serve as a control group to facilitate identifying certain patterns. The remaining data in the training dataset may include unlabeled or mixed website data, representing real-world ambiguity in detecting digital skimmers and/or malicious code.

The training dataset may be split into training (80%) and testing/validation (20%) datasets to facilitate optimizing model accuracy while preventing overfitting. In the example embodiment, the digital skimmer breach risk score model uses supervised learning, with algorithms such as CatBoost, selected for the algorithm's ability to handle both categorical and numerical data types efficiently. Such a training approach allows the digital skimmer breach risk score model to process complex, multi-dimensional data without compromising on interpretability, which may be a crucial factor in cybersecurity applications. Alternative training techniques, including self-supervised, unsupervised, and/or reinforcement learning, may also be utilized. Furthermore, in addition to CatBoost, the digital skimmer breach risk score model can leverage other machine learning algorithms suitable for binary classification and for mixed data types (categorical and numerical). These include, without limitation, gradient boosting frameworks like XGBoost and LightGBM, which are optimized for handling large datasets and mixed feature types. Suitable models may include ensemble methods such as Random Forests and Gradient Boosted Decision Trees. Neural network-based models, such as Feedforward Neural Networks, Multilayer Perceptrons, and TabNet, provide options for capturing complex feature interactions. Furthermore, Logistic Regression, Naïve Bayes, and Bayesian Networks offer lightweight yet effective alternative models. Specialized frameworks like H2O AutoML and hybrid models, including Wide & Deep Learning and Deep & Cross Networks, provide scalable, high-performance solutions tailored for structured data.

At operation 506, feature engineering is performed on the training dataset, and more specifically, the observational and transactional data, to prepare the data for use in training the digital skimmer breach risk score model. Feature engineering may include a process of transforming the raw training data into meaningful features by selecting, creating, and manipulating relevant variables, with the goal of improving the performance of the digital skimmer breach risk score model by providing the digital skimmer breach risk score model with a better representation of the data to learn from. For example, missing values in numerical features, such as transaction volume, may be imputed with the median of the training dataset. Observational data such as software patching status may be normalized to a scale between zero (0) and one (1) to ensure consistency across features.

Feature engineering techniques ensure that high-signal indicators, such as fraud frequency and cybersecurity scores, are appropriately weighted. Feature engineering is important for enabling the digital skimmer breach risk score model to identify patterns indicative of digital skimmer risk. Drawing on insights from both website configurations and transactional data, the invention leverages a range of features that provide a comprehensive risk profile for each merchant. These features include, but are not limited to, the following:

Observational Data Features

| | Feature | |
|---|---|---|
| Features | Type | Data Comment |
| Form field Types | Boolean | The type of input existing in URL. Like username, |
| | | password, credit card info . . . Convert to dummy |
| | | variables using One-hot encoding |
| Number of form | Numeric | The number of form field |
| fields identified | | |
| Number of | Numeric | Number of findings per toe_id |
| findings | | |
| Number of high or | Numeric | Number of high or critical findings per toe_id |
| critical severity | | |
| findings | | |
| Number of | Numeric | Number of findings with high asset value per |
| findings with high | | toe_id. |
| asset value | | Asset value of a website based on its characteristics |
| | | such as whether it contains a form that takes |
| | | payment and PII information from users; it ranges |
| | | from 1 to 5 with larger number indicating higher |
| | | asset value (1 - idle, 2 - low, 3 - medium, 4 - high, |
| | | 5 - key. |
| Number of | Numeric | Number of high priority findings: Based on a |
| findings with high | | combination of severity and asset value indicating |
| priority | | the importance to fix the finding; |
| asset_value_id | Numeric | Asset value of a website based on its characteristics |
| | | such as whether it contains a form that takes |
| | | payment and PII information from users; it ranges |
| | | from 1 to 5 with larger number indicating higher |
| | | asset value (1 - idle, 2 - low, 3 - medium, 4 - high, |
| | | 5 - key. |
| Host count | Numeric | Based on the IT profile, the fragmentation of |
| | | hosting. High Fragmentation of hosting with many |
| | | hosting providers will add management complexity |
| | | and increase cybersecurity risks |
| Data Loss Event | Numeric | Number of data loss events based on public records |
| Software Patching | Numeric | Software vulnerabilities with CVSS rating of High |
| score | | or Critical |
| Application | Numeric | Missing common security practices in |
| Security score | | applications that collect sensitive data |
| Web Encryption | Numeric | Errors in encryption configuration in systems |
| score | | that collect and transmit sensitive data |
| Email Security | Numeric | Security issues in active email servers and |
| score | | domains that increase susceptibility to phishing |
| | | and data theft |
| DNS Security | Numeric | Active domains (domains that are not parked) |
| score | | missing domain hijacking protection |
| System Reputation | Numeric | systems exhibiting malicious activities such as |
| score | | communicating with botnet controllers, block-listed |
| | | for attempting to compromise other systems or |
| | | spamming. |
| Hosting provider | Categorical | Whether the merchant belongs to the top 10 major |
| | | hosting provider |
| Finding | Categorical | The location the vulnerability was found on. |
| Auth_detected | Boolean | Whether authentication info is contained in the |
| | | URL |
| Shared_ip | Boolean | Whether the IP address used for hosting multiple |
| | | domains on a single server. |

Transactional Data Features

| | Feature | |
|---|---|---|
| Features | Type | Data Comment |
| Country/Region | Categorical | Merchant Country or a region |
| High Risk | Boolean | High risk countries for card fraud and ML by FATF |
| Country | | Top Highest-Risk Countries for Cyber Threats by |
| | | SEON |
| Network Age | Categorical | The time since the first transaction and the latest |
| | | transaction for each merchant, with 4 groups. (“>5 |
| | | years”, “1 to 5 years”, “0.5-1 year”, “<6 months”) |
| Payment | Numeric | The number of transactions going through each |
| Facilitator | | payment facilitator separately. Including PayPal, |
| Approved Count | | Stripe, Square, Pag Seguro |
| 3DS acceptance | Boolean | Whether the merchant accepted 3DS transactions. 0 = |
| | | no authentication was processed for a given |
| | | merchant, 1 = authentication was processed). Or |
| | | more than 50% of txns went through 3DS |
| Merchant Size | Categorical | Based on the total transaction of the past 12 months, |
| | | the size of the merchants can be group by managed, |
| | | large, medium, small, and micro |
| Merchants | Boolean | High risk merchants that are compromised and |
| Flagged by CPP | | identified by CPP model |
| MCC/industry | Categorical | MA Data Warehouse |
| | | Industry (esp. high-risk industry indicator - gaming, |
| | | financial services, quasi-cash, Dating/Escort |
| | | Services, Delayed Delivery Merchants, Jewelry) |
| | | Cardinality: |
| | | MCCs: 1278 |
| | | Industries: 100 |
| | | Super Industries: 35 |
| | | Classifications: 31 |
| | | MCC Groups: 7 (CASH, T + E, RETAIL, SERVICES, |
| | | DEPOSIT TXNS, MCC INVALID, MCC |
| | | UNKNOWN) |

At operation 508, the digital skimmer breach risk score model is trained on the training dataset using the training algorithm, at which a set of decision trees is built consecutively. For example, after the training data has been pre-processed and the feature engineering is complete, the digital skimmer breach risk score model may be trained using a systematic process that ensures the digital skimmer breach risk score model can accurately classify merchant websites as compromised or not compromised.

In an example, the training dataset, which includes labeled examples (e.g., digital skimmer vs. non-digital skimmer data), may be inputted into the digital skimmer breach risk score model, for example, as feature input vectors. The feature input vectors include both encoded observational data (e.g., out-of-date software, DNS vulnerabilities) and transactional data (e.g., transaction volume, fraudulent transaction frequency). That is, the observational and transactional data are converted to numerical values using techniques such as one-hot encoding or embeddings and the like. Numerical features may be normalized or standardized. The digital skimmer breach risk score model may optimize a loss function suitable for binary classification, which measures the difference between predicted probabilities and actual labels. The digital skimmer breach risk score model may use feature importance techniques to weigh inputs such as the number of hostile hosts, software patching scores, and fraud frequency, prioritizing features with the highest predictive power. For example, during training and validation, feature importance scores may be generated to provide insights into the attributes most influential in determining a merchant website's risk level. In an embodiment, the feature importance scores may be calculated using known techniques, such as shapley additive explanation (SHAP) values, which quantify the contribution of each feature to the digital skimmer breach risk score model's predictions. For example, SHAP analysis may reveal that certain vulnerabilities in content management systems (CMS) and outdated encryption practices are strong indicators of digital skimmer risks. This interpretability supports users in prioritizing remediation efforts by focusing on the most critical security vulnerabilities identified by the model.

Thus, during training of the digital skimmer breach risk score model, one or more feature input vectors representing the individual websites in the training data may be passed to the digital skimmer breach risk score model. The digital skimmer breach risk score model may transform the feature input vectors through multiple layers or decision trees, resulting in one or more latent vectors (e.g., a latent vector for each feature input vector). The latent vectors may be used to compute the breach risk score, which is a probability score for the two classes (e.g., digital skimmer or non-digital skimmer). The probability may be compared with a data label (e.g., digital skimmer=1, non-digital skimmer=0) to compute a loss value using a loss function. Gradients of the loss function may be calculated with respect to weights and biases in the digital skimmer breach risk score model. Using an optimization algorithm (e.g., gradient descent algorithm), the digital skimmer breach risk score model may update the model parameters to minimize the loss, refining the mapping from feature input vectors to output probabilities. The transformations applied during training may refine the latent space. Digital skimmer websites, for example, may form dense clusters in specific regions of the latent space based on shared patterns (e.g., high fraud frequency and unpatched software). Non-digital skimmer websites may be distributed in a different region of the latent space, separated by distinct feature characteristics. Such a structured approach to training may ensure that the digital skimmer breach risk score model is robust in detecting digital skimmers.

At operation 510, the digital skimmer breach risk score model is tested and tuned, for example, using the testing/evaluation dataset. For example, to fine tune the digital skimmer breach risk score model and improve performance, hyperparameter optimization may be conducted using various methods, such as grid search or random search. In some examples, the hyperparameters that may be tuned to include, for example, learning rate, number of trees, maximum depth, L2 regularization, and the like. Learning depth controls how much the digital skimmer breach risk score model adjusts weights during training; number of trees determines the size of the ensemble in boosted tree models; maximum depth limits the depth of each decision tree to prevent overfitting; and L2 regularization adds a penalty to large weights to control overfitting. As noted above, the testing/validation dataset is used to evaluate different combinations of hyperparameters to identify a configuration yielding the best performance. After identifying the best-performing configuration, all hyperparameters (e.g., learning rate, maximum tree depth, regularization parameters, etc.) may be finalized and locked-in.

At operation 512, the digital skimmer breach risk score model may be evaluated, for example, using precision and recall metrics. Precision measures the accuracy of positive predictions (i.e., how many predicted “compromised” websites were actually compromised), while recall measures the digital skimmer breach risk score model's ability to identify all actual risks. Both metrics may be important in cybersecurity applications, where an overly sensitive digital skimmer breach risk score model could lead to excessive false positives, while a less sensitive digital skimmer breach risk score model might miss significant threats. These two metrics also help balance various aspects of a digital skimmer breach risk score model's performance. For example, there is often a trade-off between precision and recall, so both must be considered to evaluate how well the digital skimmer breach risk score model performs under different business needs.

In some embodiments, the digital skimmer breach risk score model may be retrained (e.g., modified) in view of initial testing utilizing the testing/validation dataset, to determine initial performance in terms of capabilities, efficiency, cost, and accuracy with reference to the system objective(s) for which the digital skimmer breach risk score model is to be used. A retrained digital skimmer breach risk score model may include changes to model features such as input vectors and/or embeddings (e.g., variable input type(s) and/or weightings or the like), and/or may include changes to the composition of the digital skimmer breach risk score model itself (e.g., weightings and/or connections at hidden layers in the case of a deep neural network or the like).

At operation 514, a configurable threshold value may be set and tuned. For example, the digital skimmer breach risk score model may include a configurable threshold value, allowing for adjustments to precision and recall based on real-world testing and evolving cybersecurity needs. For instance, in high-security scenarios, a higher recall may be prioritized to ensure that no potential threats are missed, even if this results in some false positives. Conversely, environments with low tolerance for false positives may favor higher precision. This flexibility allows the digital skimmer breach risk score model to be adapted to a variety of cybersecurity and business requirements. In an example, the vulnerability assessment monitor 12 may provide a user interface or API endpoint for adjusting sensitivity settings. This allows users to define custom thresholds based on business needs, with options for saving multiple configurations for different operational scenarios.

At operation 516, the digital skimmer breach risk score model is prepared for deployment in a production environment to process new merchant website data. In an embodiment, preparing the digital skimmer breach risk score model for deployment may include serializing the digital skimmer breach risk score model into a deployable format. Serialization includes converting the digital skimmer breach risk score model, along with its parameters and configurations, into a file format that can be loaded and executed in different software environments. Formats may include, for example, Python-native serialization formats for a local deployment or formats like Open Neural Network Exchange (ONNX) and Predictive Model Markup Language (PMML) for use across various frameworks and platforms.

At operation 518, the digital skimmer breach risk score model's serialized file is saved and/or stored by the vulnerability assessment monitor 12, for example, to the vulnerability assessment data store 14. The serialized file includes the digital skimmer breach risk score model's architecture, weights, and metadata, such as feature names and the hyperparameter configuration used during training.

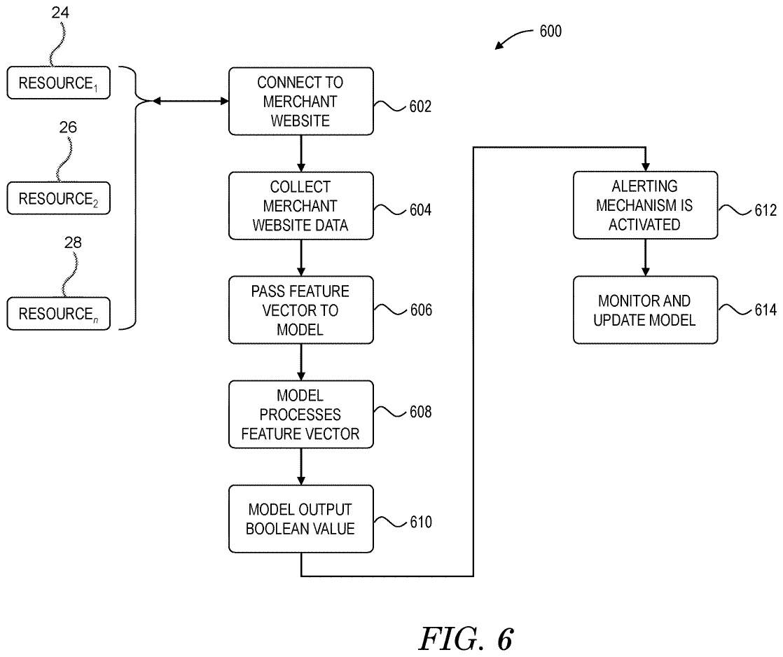

FIG. 6 is a flowchart illustrating an exemplary computer-implemented method 600 for utilizing the digital skimmer breach risk score model to predict whether a merchant website includes a digital skimmer and/or malicious code, in accordance with one embodiment of the present disclosure. The operations described herein may be performed in the order shown in FIG. 6 or may be performed in a different order. Furthermore, some operations may be performed concurrently as opposed to sequentially. In addition, some operations may be optional.

The computer-implemented method 600 is described below, for ease of reference, as being executed by exemplary devices and components introduced with the embodiments illustrated in FIGS. 1-4. In one embodiment, the method 600 may be implemented by the vulnerability assessment monitor 12 (shown in FIG. 1). While operations within the method 600 are described below regarding the vulnerability assessment monitor 12, the method 600 may be implemented on other computing devices and/or systems through the utilization of processors, transceivers, hardware, software, firmware, or combinations thereof. However, a person having ordinary skill will appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

In operation, the digital skimmer breach risk score model may be deployed in various environments, including, for example, on-premises servers or cloud-based platforms. For real-time evaluation of a merchant website, the digital skimmer breach risk score model may be hosted as a service that processes individual requests for risk assessment, such as evaluating a merchant website during onboarding. For batch evaluation, the digital skimmer breach risk score model may be used to substantially simultaneously analyze data obtained from multiple websites, enabling assessments of a large dataset. The deployment infrastructure may be designed to handle new data inputs efficiently, ensuring low latency and high throughput during evaluation.

In the example embodiment, the vulnerability assessment monitor 12 (shown in FIG. 1) includes a merchant website data delivery system, which may include any necessary tools for operation of a feature engineering pipeline 620 within the system 10 (shown in FIG. 1). The feature engineering pipeline 620 ensures that raw data collected from a merchant website and the merchant's associated transaction data is processed in the same manner as the training data for training the digital skimmer breach risk score model. Features such as transaction volume, software patching scores, and fraud frequency may be normalized or encoded before being fed into the digital skimmer breach risk score model. The feature engineering pipeline 620 may also include methods for handling missing data or outliers, ensuring robustness during real-world application of the digital skimmer breach risk score model to merchant websites.

At operation 602, the vulnerability assessment monitor 12 connects to a merchant website, such as one or more of the resources 24, 26, and 28 (shown in FIG. 1) via the communication network 16 (shown in FIG. 1). During connection, the vulnerability assessment monitor 12 may identify the merchant associated with the merchant website.

At operation 604, observational and transactional data are collected from the merchant website using scanning tools and/or one or more of the private or public databases 18 and 20 using database queries and/or APIs. The collected observational and transactional data are processed by the feature engineering pipeline 620 where the data are transformed into a feature input vector.

At operation 606, the feature engineering pipeline 620 passes the feature input vector to the digital skimmer breach risk score model. In the exemplary embodiment, the feature input vector encapsulates the features of a specific merchant website and its associated data in a format that the digital skimmer breach risk score model can process. That is, the feature input vector is a distilled numerical abstraction of the raw data collected for the specific merchant website, containing all the essential information the digital skimmer breach risk score model requires to classify the website as high-risk or low risk for having a digital skimmer. As discussed above, the feature input vector (i.e., an abstraction of the raw data collected for a merchant website) includes information derived from the observational data and the transactional data associated with the merchant website and/or the merchant. The observational data may include technical attributes of the website, such as software patching scores, encryption configurations, network security, and any known vulnerabilities. The transactional data may include business-related metrics, including transaction volume, frequency of fraudulent transactions, merchant size, and geographic region.

In an example, the feature engineering pipeline 620 may begin with data cleaning and validation to address missing values, outliers, and data type inconsistencies. As discussed herein, missing numerical values may be imputed with statistical measures like the median, while categorical features may be replaced with a placeholder category. Outliers in numerical features, such as transaction volume or fraud frequency, may either be capped or excluded based on potential impact. The cleaned data may undergo a transformation to standardize and encode features for model consumption. Continuous variables, such as patching scores and fraud frequency, may be normalized or otherwise transformed. Categorical features, such as merchant industry type and region, may be encoded using one-hot encoding and/or embeddings. The processed features may be aligned in a determined order to form the feature input vector. In some embodiments, the feature engineering pipeline 620 may also incorporate dimensionality reduction techniques, such as removing low-variance features or applying various techniques to facilitate reducing computational complexity. The feature input vector ensures that the digital skimmer breach risk score model receives structured, high-quality data that accurately reflects the characteristics of the merchant website, enabling precise predictions during evaluation.

At operation 608, the digital skimmer breach risk score model processes the feature input vector. For example, the feature input vector is processed through the digital skimmer breach risk score model to generate a latent vector. The latent vector is an intermediate representation that captures relationships between features. The latent vector is mapped into a latent space, where similar merchant websites cluster based on shared characteristics. The digital skimmer breach risk score model evaluates the position of the latent vector in this space to compute a probability score indicating the likelihood of the website containing a digital skimmer.

The probability score is compared to the configurable threshold value set during training of the digital skimmer breach risk score model, and at operation 610, the digital skimmer breach risk score model produces a Boolean output, identifying whether the merchant website is potentially compromised by a digital skimmer and/or malicious code. Based on the Boolean output, the digital skimmer breach risk score model provides insights into which features contributed most to the risk assessment, enabling actionable mitigation steps.

In an embodiment, at operation 612, when the digital skimmer breach risk score model detects a potential digital skimmer or identifies a potentially compromised merchant website, an alerting mechanism is activated. The alerting mechanism may involve a multi-tiered notification process, including transmitting an alert message to the merchant associated with the merchant website, one or more payment processors associated with transactions processed by the merchant website, and/or one or more financial institutions (such as issuers) associated transaction cards processed by the merchant website. For example, the alerting mechanism may include an API layer that interfaces with payment processors, merchant systems, and issuer systems. The API may transmit JSON-formatted notifications containing risk scores, detected vulnerabilities, and recommended mitigation actions, enabling automated risk management workflows. The alerting mechanism may also include flagging the merchant website as potentially compromised or high risk, such as adding the merchant website to a Blacklist, and monitoring or blocking high-risk transactions originating from the merchant website. The alerting mechanism facilitates prompt investigation and mitigation efforts by the merchant to protect customer transactions, enables monitoring future transactions or flagging compromised transaction cards by the issuer to prevent fraud, and supports proactive risk management in the broader payment ecosystem.

In an embodiment, at operation 614, the digital skimmer breach risk score model is monitored continuously and updated to ensure its predictions remain accurate and reliable. To ensure the digital skimmer breach risk score model remains accurate and robust, additional real-world feedback data may be periodically integrated into the validation process. This real-world feedback data may include new merchant websites scanned after the initial training phase and transactional records reflecting recent activity. The feedback data may be used to update the digital skimmer breach risk score model's parameters, ensuring adaptability to evolving digital skimming tactics. For example, feedback loops may be established to collect data on prediction outcomes, highlighting misclassifications or cases of data drift where feature distributions differ from the training dataset. If a previously unknown digital skimming tactic is identified, the associated data may be labeled and integrated into the digital skimmer breach risk score model's training or periodic retraining process. The monitoring process ensures the digital skimmer breach risk score model remains effective in detecting digital skimmers and/or malicious code while adapting to changing patterns and threats.

The disclosed digital skimmer breach risk score model provides significant technological advancements in the field of cybersecurity and digital skimmer detection, for example, by integrating a novel machine learning framework that improves upon existing methods for detecting malicious code on merchant websites. Unlike conventional approaches that rely solely on static website scans to identify known malicious snippets, the digital skimmer breach risk score model employs a multi-faceted system that combines observational website data and transactional merchant data to create a comprehensive risk assessment model. The digital skimmer breach risk score model represents a specific, technological improvement that enhances the accuracy and reliability of digital skimmer detection, while addressing the limitations of existing tools in handling incomplete or dynamic website content.

The digital skimmer breach risk score model provides a technical solution to the problem of undetected digital skimmers by using a trained binary classification model capable of processing diverse and complex data inputs, such as software patching scores, encryption practices, fraud frequency, and transaction volume. By incorporating feature engineering, latent vector mapping, and latent space analysis, the invention transforms raw, disparate data into structured feature input vectors that enable the model to detect subtle patterns indicative of compromise. This approach facilitates the detection of previously unknown digital skimmer behaviors, representing a significant advancement over existing heuristic-based methods.

Furthermore, the digital skimmer breach risk score model operates as an automated, scalable system that applies real-time or on-demand analysis to evaluate websites for potential vulnerabilities. This technological framework reduces the burden on human analysts, improves response times, and provides actionable mitigation recommendations based on feature importance and risk scores. The integration of continuous monitoring, feedback loops, and retraining mechanisms ensures that the system adapts dynamically to evolving threats, addressing the ever-changing landscape of cybersecurity risks. Thus, the digital skimmer breach risk score model improves the functionality and performance of digital security systems by enabling robust, data-driven skimmer detection that reduces false positives and enhances overall system efficiency.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

The detailed description is to be construed as exemplary only and does not describe every embodiment because describing every embodiment would be impractical. Numerous alternative embodiments may be implemented, using either current technology or technology developed after the filing date of this application, which would still fall within the scope of the invention.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

As used herein, the term “database” includes either a body of data, a relational database management system (RDBMS), or both. As used herein, a database includes, for example, and without limitation, a collection of data including hierarchical databases, relational databases, flat file databases, object-relational databases, object-oriented databases, and any other structured collection of records or data that is stored in a computer system. Examples of RDBMS's include, for example, and without limitation, Oracle® Database (Oracle is a registered trademark of Oracle Corporation, Redwood Shores, Calif.), MySQL, IBM® DB2 (IBM is a registered trademark of International Business Machines Corporation, Armonk, N.Y.), Microsoft® SQL Server (Microsoft is a registered trademark of Microsoft Corporation, Redmond, Wash.), Sybase® (Sybase is a registered trademark of Sybase, Dublin, Calif.), and PostgreSQL® (PostgreSQL is a registered trademark of PostgreSQL Community Association of Canada, Toronto, Canada). However, any database may be used that enables the systems and methods to operate as described herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor includes a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, later, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

What is claimed is:

1. A system comprising:
a data store including a training dataset and a testing dataset, the training and testing datasets including observational data derived from merchant website scans and transactional data obtained from one or more payment processors;
one or more processors; and
a memory device having executable instructions that, when executed by the one or more processors, cause the one or more processors to perform operations comprising:
retrieving the training dataset from the data store;
preprocessing the training dataset by imputing missing values and encoding categorical features into a machine-readable format;
performing feature engineering on the training dataset, the feature engineering including transforming raw data of the training dataset into one or more structured feature vectors based on one or more attributes of the raw data;
generating a digital skimmer breach risk score model by training a machine learning model using the preprocessed and engineered training dataset, the training including optimizing a loss function to minimize misclassifications between compromised and non-compromised websites;
retrieving the testing dataset from the data store; and
validating the digital skimmer breach risk score model on the testing dataset to evaluate performance metrics, including precision and recall.

2. The system in accordance with claim 1,
the feature engineering further including generating one or more first attributes based on the observational data, the one or more first attributes including one or more of the following: website configuration data, encryption practices, software patching status, and DNS security configurations.

3. The system in accordance with claim 1,
the feature engineering further including generating one or more second attributes based on the transactional data, the one or more second attributes including one or more of the following: transaction volume, frequency of fraudulent transactions, merchant industry classification, and geographic region.

4. The system in accordance with claim 1,
the executable instructions further causing the one or more processors to perform an operation comprising updating the digital skimmer breach risk score model by incorporating feedback from new labeled data representing emerging patterns of digital skimming or malicious code.

5. The system in accordance with claim 1,
the machine learning model includes one of the following: a gradient-boosted decision tree algorithm, a neural network, wide & deep learning, and a deep & cross network.

6. The system in accordance with claim 1,
the validating of the digital skimmer breach risk score model further including using real-world data obtained from additional merchant websites to refine precision and recall metrics.

7. The system in accordance with claim 1,
the preprocessing of the training dataset further including detecting and handling outliers by capping or excluding extreme values for numerical attributes and replacing missing categorical values with a placeholder category.

8. A method comprising:
retrieving a training dataset from a data store, the training dataset including first observational data derived from merchant website scans and first transactional data obtained from one or more payment processors;
preprocessing the training dataset by imputing missing values and encoding categorical features into a machine-readable format;
performing feature engineering on the training dataset, the feature engineering including transforming raw data of the training dataset into one or more structured feature vectors based on one or more attributes of the raw data;
generating a digital skimmer breach risk score model by training a machine learning model using the preprocessed and engineered training dataset, the training including optimizing a loss function to minimize misclassifications between compromised and non-compromised websites;
retrieving a testing dataset from the data store, the testing dataset including second observational data derived from the merchant website scans and second transactional data obtained from the one or more payment processors; and
validating the digital skimmer breach risk score model on the testing dataset to evaluate performance metrics, including precision and recall.

9. The method in accordance with claim 8,
the feature engineering including generating one or more first attributes based on the first observational data, the one or more first attributes including one or more of the following: website configuration data, encryption practices, software patching status, and DNS security configurations.

10. The method in accordance with claim 8,
the feature engineering including generating one or more second attributes based on the first transactional data, the one or more second attributes including one or more of the following: transaction volume, frequency of fraudulent transactions, network age, merchant industry classification, and geographic region.

11. The method in accordance with claim 8, further comprising:
updating the digital skimmer breach risk score model by incorporating feedback from new labeled data representing emerging patterns of digital skimming or malicious code.

12. The method in accordance with claim 8,
the machine learning model including one of the following: a gradient-boosted decision tree algorithm, a neural network, wide & deep learning, and a deep & cross network.

13. The method in accordance with claim 8, further comprising:
generating one or more feature importance scores for the attributes of the structured feature vectors to identify key indicators of compromised merchant websites.

14. A non-transitory computer-readable medium having executable instructions thereon that, when executed by a computer having one or more processors, cause the one or more processors to perform operations comprising:
retrieving a training dataset from a data store, the training dataset including first observational data derived from merchant website scans and first transactional data obtained from one or more payment processors;
preprocessing the training dataset by imputing missing values and encoding categorical features into a machine-readable format;
performing feature engineering on the training dataset, the feature engineering including transforming raw data of the training dataset into one or more structured feature vectors based on one or more attributes of the raw data;
generating a digital skimmer breach risk score model by training a machine learning model using the preprocessed and engineered training dataset, the training including optimizing a loss function to minimize misclassifications between compromised and non-compromised websites;
retrieving a testing dataset from the data store, the testing dataset including second observational data derived from the merchant website scans and second transactional data obtained from the one or more payment processors; and
validating the digital skimmer breach risk score model on the testing dataset to evaluate performance metrics, including precision and recall.

15. The non-transitory computer-readable medium in accordance with claim 14,
the feature engineering including generating one or more first attributes based on the first observational data, the one or more first attributes including one or more of the following: website configuration data, encryption practices, software patching status, and DNS security configurations.

16. The non-transitory computer-readable medium in accordance with claim 14,
the feature engineering including generating one or more second attributes based on the second transactional data, the one or more second attributes including one or more of the following: transaction volume, frequency of fraudulent transactions, network age, merchant industry classification, and geographic region.

17. The non-transitory computer-readable medium in accordance with claim 14,
the executable instructions further causing the one or more processors to perform an operation comprising updating the digital skimmer breach risk score model by incorporating feedback from new labeled data representing emerging patterns of digital skimming or malicious code.

18. The non-transitory computer-readable medium in accordance with claim 14,
the machine learning model including one of the following: a gradient-boosted decision tree algorithm, a neural network, wide & deep learning, and a deep & cross network.

19. The non-transitory computer-readable medium in accordance with claim 14,
the executable instructions further causing the one or more processors to perform an operation comprising generating feature importance scores for attributes in the structured feature vectors to identify key indicators of compromised merchant websites.

20. The non-transitory computer-readable medium in accordance with claim 14,
the executable instructions further causing the one or more processors to perform an operation comprising validating the digital skimmer breach risk score model using additional real-world data obtained from merchant websites to enhance accuracy metrics.
